(19) United States
(12) Patent Application Publication
(10) Pub. No.: US 2014/0232224 A1
(43) Pub. Date: Aug. 21, 2014

(54) Angular momentum engine

(71) Applicant: MICHAEL JOSEPH CAREW, FRANKLIN, NJ (US)

(72) Inventor: MICHAEL JOSEPH CAREW, FRANKLIN, NJ (US)

(21) Appl. No.: 13/987,696

(22) Filed: Aug. 21, 2013

Related U.S. Application Data
(63) Continuation-in-part of application No. 13/199,849, filed on Sep. 9, 2011, now abandoned.

(51) Int. Cl. H02K 7/065

(52) U.S. Cl. CPC H02K 7/065
USPC 310/74

(57) ABSTRACT

This Angular Momentum Engine uses Servo Motors, connected to a planetary gearbox, to spin-up a high speed inertia load, a ‘point mass’ spinning horizontally around a vertical axis, like the ball on the end of a string.

“Whenever an object moves in a circular path we know the object is accelerating because the object is continuously changing direction. Accelerations are caused by net forces on an object. In the case of an object moving in a circular path, the net force is a special force called a centripetal force. Centripetal force in Latin means ‘center seeking’.” As this ‘point mass’ is rotating in a circular path so too is the ‘center seeking’ centripetal force.

In order for this rotating centripetal force to have practical applications such as to power commercial automobiles, the rotating centripetal force must be changed to linear, straight line centripetal force, the subject matter of this patent.

### RELATED U.S. PATENT DOCUMENTS APPLICATIONS

This patent application claims a Continuation in Part to application Ser. No. 13/199,849 filed Sep. 9, 2011 Title of Invention Angular Momentum Engine.

### BACKGROUND

State of the art Motion Control System and equipment are used in controlling the Angular Momentum and positioning of a ‘point mass’ rotating horizontally around a vertical axis to change the rotating ‘center seeking’ centripetal force to a linear ‘center seeking’ centripetal force. FIG. 6

This invention uses this linear ‘center seeking’ centripetal force to accelerate a vehicle such as a commercial automobile. The design is new relative to how the forces are created and used but the technology has been solidly embraced in the laws of physics for many decades.

While it is common place for an engine to create a force to push a vehicle, or an equal and opposite reaction to propel an aircraft, this linear ‘center seeking’ force pulls the vehicle. Such changes to normal are exhibited throughout the specifications and therefore requires a perspective relative to a changing environment.

### BRIEF DEESCRIPTION OF THE DRAWINGS

FIG. 1

FIG. 2—System design

FIG. 3—Overlay of FIG. 1 and FIG. 2
Relative position of Point Mass 1 to Point Mass 2

FIG. 4—Simple Planetary Gearbox

FIG. 5a—Timing Documentation—Spin-up
Point Mass timing marks before and after spin-up

FIG. 5b—Timing Documentation—Forward Power Timing Marks
Neutral, Minimum, Half, Full Power Positions

FIG. 5c—Timing Documentation—Reverse Power Timing Marks
Neutral, Minimum, Half, Full Power Positions

FIG. 5d—Timing Documentation—RPM

FIG. 5e—Illustration of Patent design

FIG. 6—Definition of Centripetal Force

FIG. 7—Centripetal Force Calculation

FIG. 8—Patent Design compared to a simple planetary gearbox

FIG. 9—Low Mass, High Speed Centripetal Forces examples

FIG. 10—High Mass, Low Speed Centripetal Forces examples

FIG. 11—Secrecy Order

### BRIEF DESCRIPTION OF THE INVENTION

This invention changes rotating ‘center seeking’ centripetal force to linear ‘center seeking’ centripetal force simply by changing the relative velocity and relative motion of a ‘point mass’ to a stationary reference point.

As an analogy Man ‘A’ sitting on a train while its leaving the train station is accelerated to a constant speed of 3 feet per second to the west. He stands up and walks at the same constant speed of 3 feet per second, but in the opposite direction to the east.

From the perspective of Man ‘A’ on the train, he is moving east at a constant speed of 3 feet per second in the opposite direction the train is moving and stationary relative to Man ‘B’ standing at rest, motionless on the train platform.

From the perspective of Man ‘B’ on the train platform, Man ‘A’ on the train is stationary relative to him, and the train is moving at a constant speed of 3 feet per second to the west.

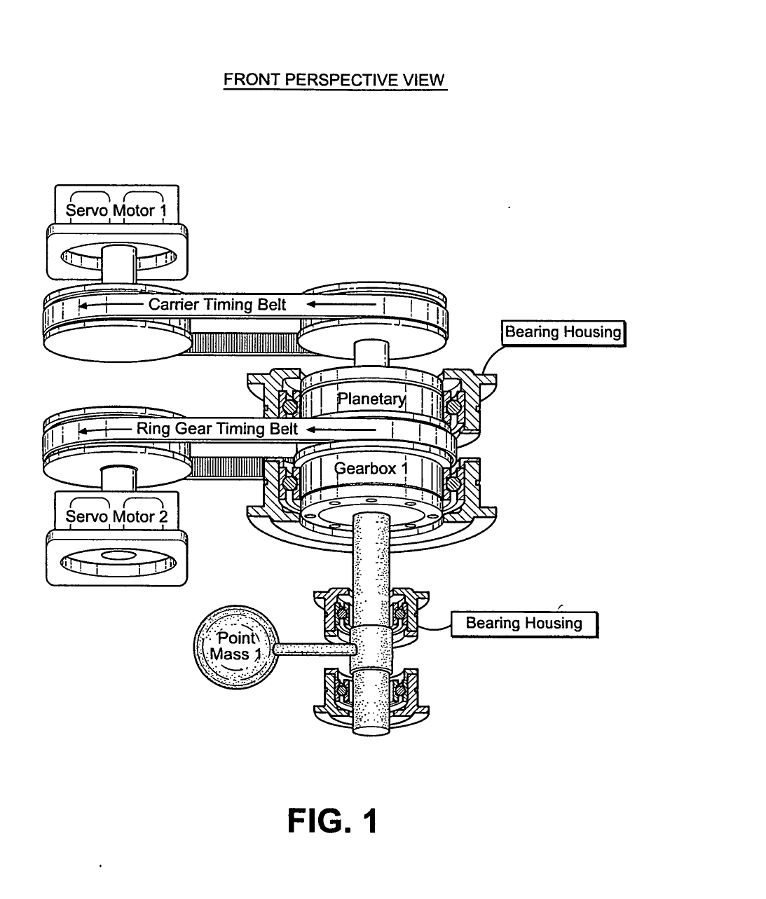

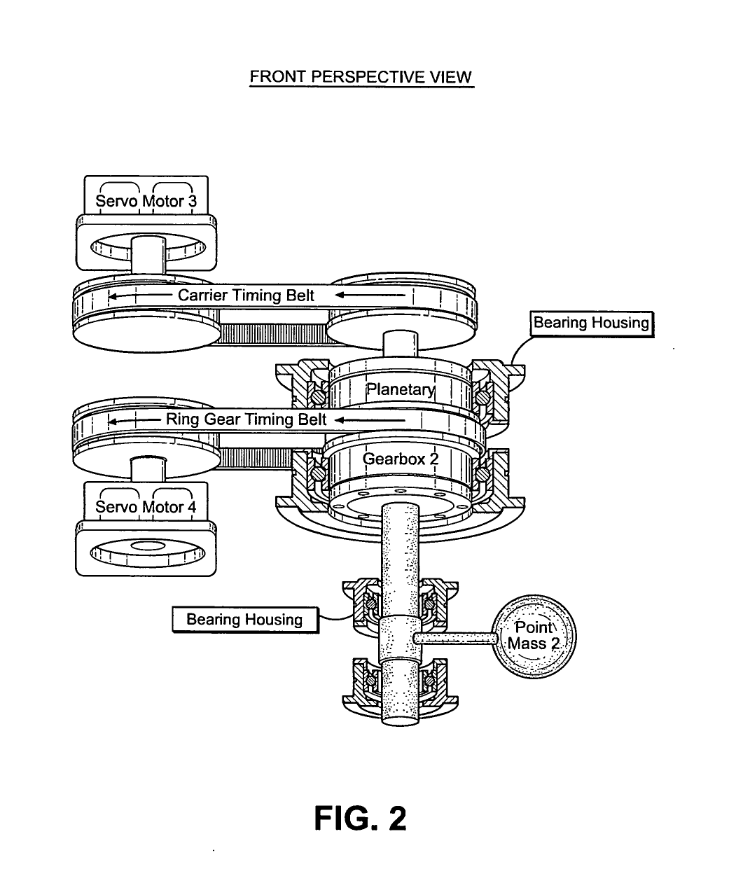

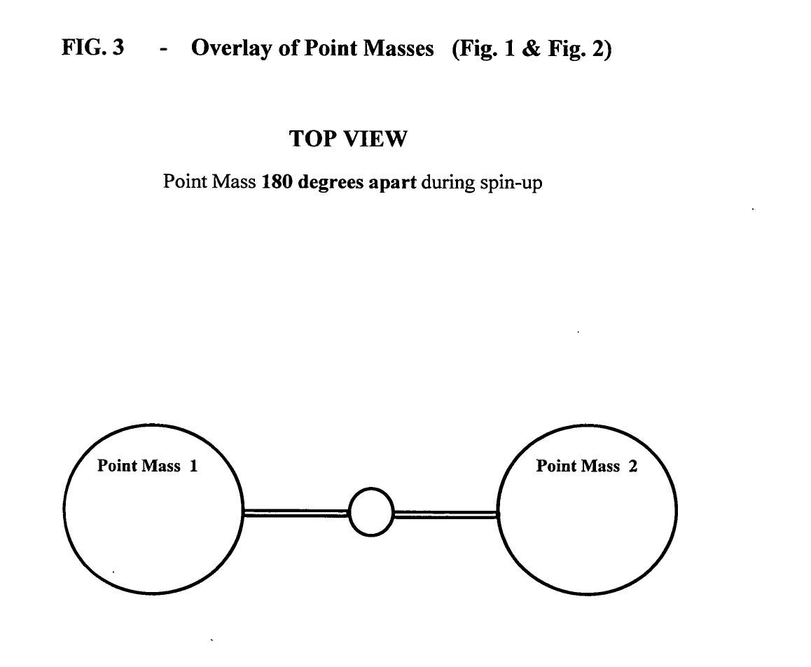

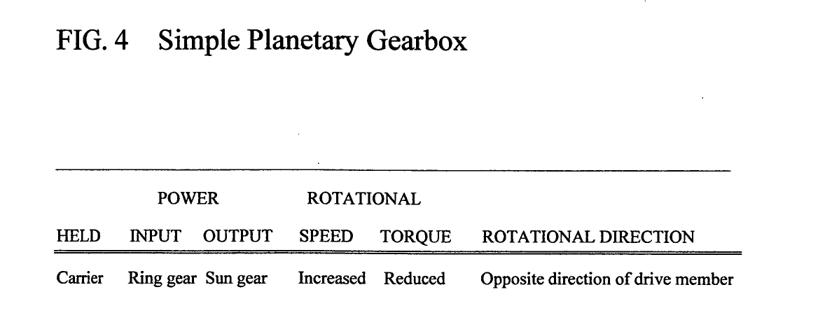

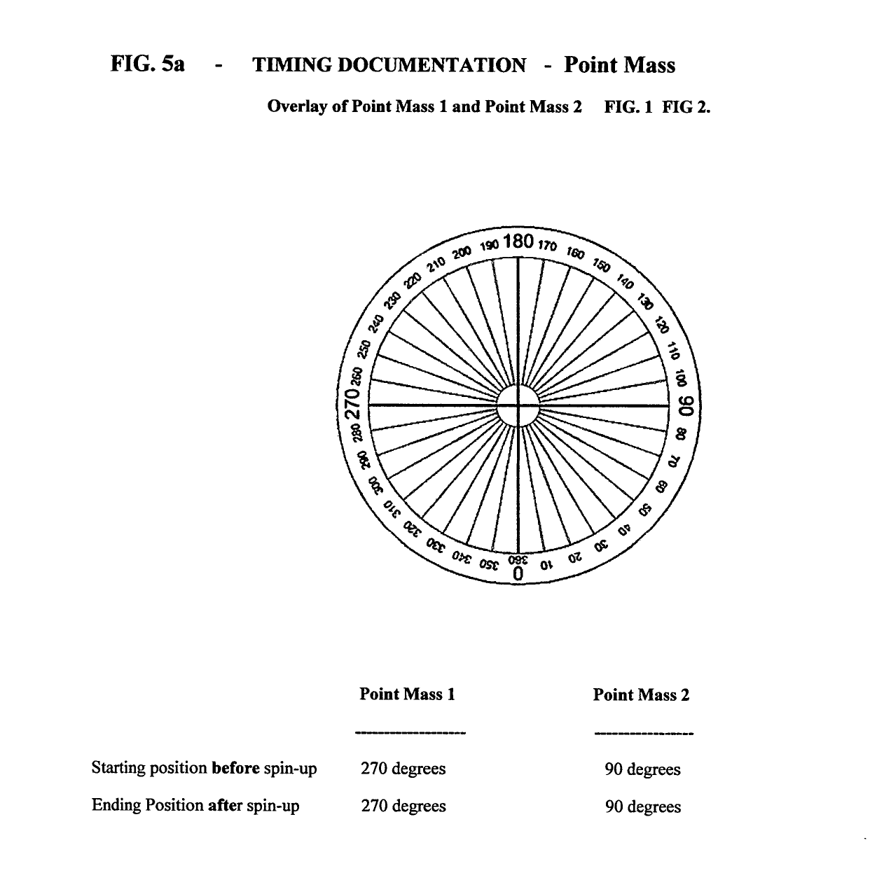

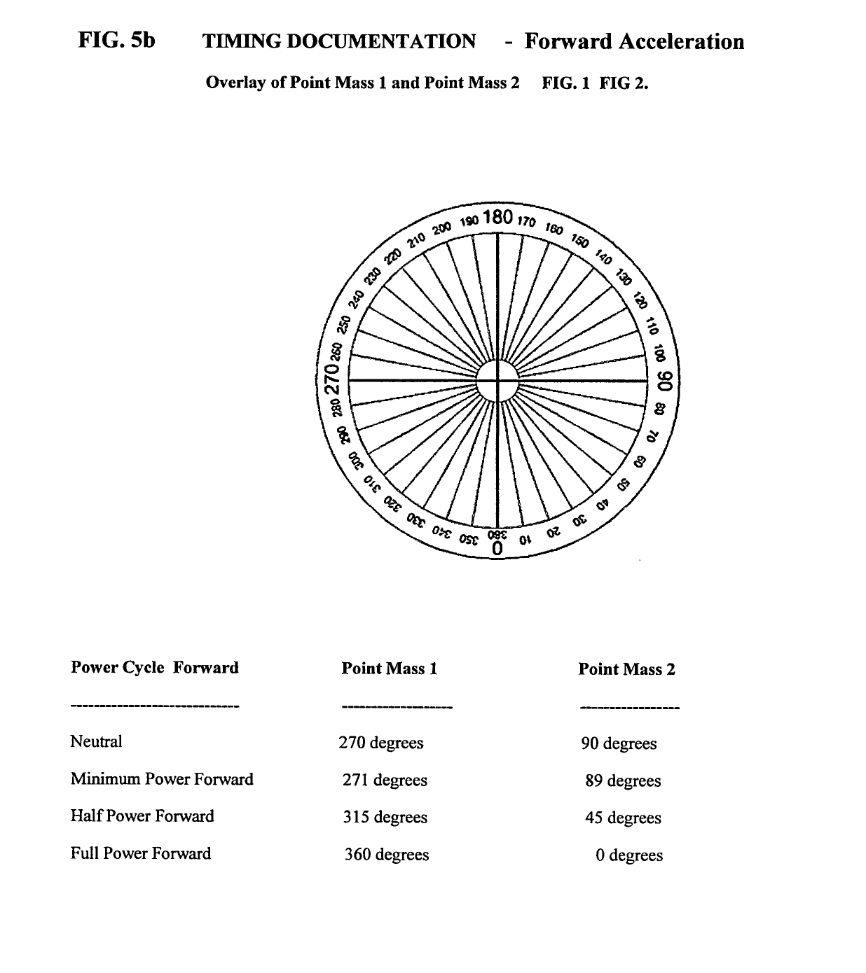

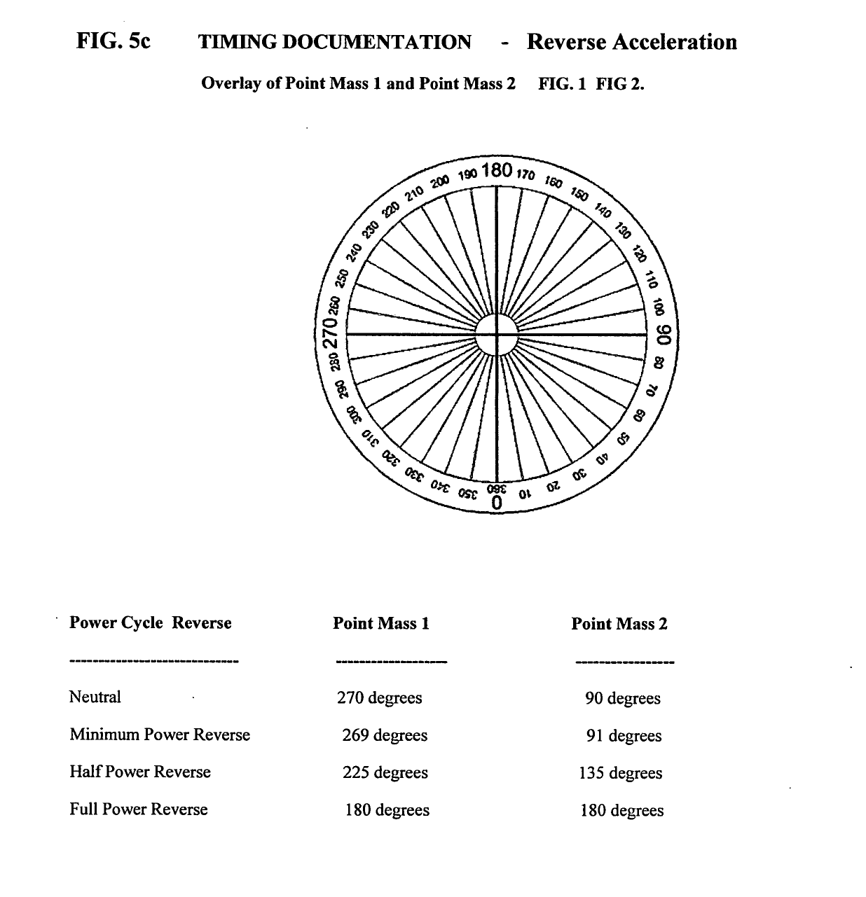

In this patent design, the ‘planetary gearbox’ and ‘point mass’ are accelerated to a constant relative rotational velocity counter-clockwise. The ‘point mass’ is then accelerated to the same constant relative rotational velocity but in the opposite direction of the gearbox, clockwise. FIG. 1 FIG. 2

From the perspective of the ‘point mass, it is rotating clockwise at a constant speed but in the opposite direction the gearbox is rotating and stationary relative to an ‘Observer’ standing at rest, motionless.

From the perspective of an ‘Observer’ the ‘point mass’ is stationary relative to him, and the gearbox is rotating at a constant speed counter-clockwise.

The ‘point mass’ is now moving at the same speed counter-clockwise as it is clockwise and therefore to a stationary observer the point mass appears not to be moving relative to him. This positioning of the relative velocity and relative motion of the ‘point mass’ to a stationary reference point results in the ‘center seeking’ centripetal force being changed from rotational to linear.

This change of the ‘center seeking’ centripetal force from rotational to linear will be referred to as the ‘spin-up’ in future references.

A point mass is used in each system, ‘Point Mass 1’ in FIG. 1, ‘Point Mass 2’ in FIG. 2 to balance the rotational forces. FIG. 3 depicts an overlay of FIG. 1 and FIG. 2 illustrating the two point masses are 180 degrees apart at all times and also that the ‘point masses’ rotate in the same direction whether their motion is counter-clockwise, clockwise, or at rest relative to a stationary reference point during spin-up.

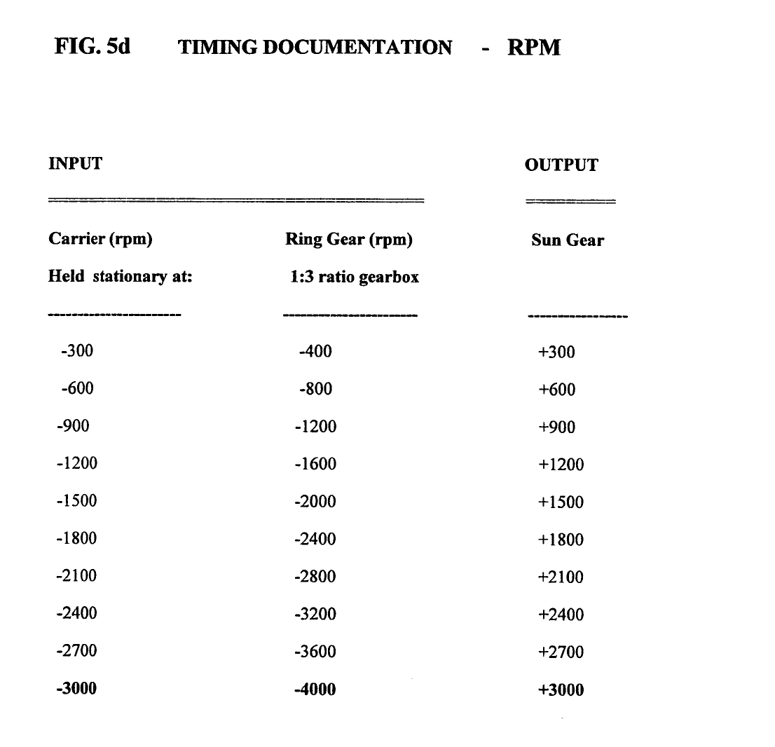

Balancing the rotational forces allows the system to spin-up vibration free and also provide a neutral position after spin-up where the net linear ‘center seeking’ forces are balanced. FIG. 5a

This balancing of forces is needed during times when the vehicle is stopped, an accelerating force is not required, or when the vehicle is on a downhill incline. Providing full to partial power is as simple as moving the ‘point masses’ to the power position.

‘Point Mass 1’ and ‘Point Mass 2’ move a maximum of 90 degrees to apply full forward or reverse power. Minimum power is 1 degree, maximum power requires a movement of 90 degrees as illustrated in FIG. 5b, FIG. 5c.

### DETAILED DESCRIPTION OF INVENTION

The planetary gearbox is utilized in changing the relative velocity and relative motion of the ‘point mass’ to a stationary reference point.

The synchronous spin-up applies a counter-clockwise torque to the ‘planetary carrier shaft’ by Servo Motor 1 & 3 and to the ‘ring gear’ by Servo Motor 2 & 4 locking the internal gears (ring, planet, sun) of the planetary gearbox which results in the gearbox and ‘point mass’ moving at a constant relative rotational velocity counter-clockwise at −3000 rpm. FIG. 1 FIG. 2

Motor 1 & 3 rpm to the planetary carrier shaft remain the same at −3000 while Motor 2 & 4 rpm to the ring gear is increased synchronously from −3000 to −4000 rpm. The addition −1000 rpm to the ring gear using a 1:3 ratio speed increaser gearbox, moves the ‘point mass’ to the same relative rotational velocity, but in the opposite direction of the gearbox, clockwise at +3000 rpm. FIG. 1 FIG. 2

The ‘point mass’ is now moving at the same speed counter-clockwise as it is clockwise and therefore to a stationary observer the ‘point mass’ appears not to be moving relative to him. This positioning of the relative velocity and relative motion of the ‘point mass’ to a stationary reference point results in the ‘center seeking’ centripetal force being changed from rotational to linear.

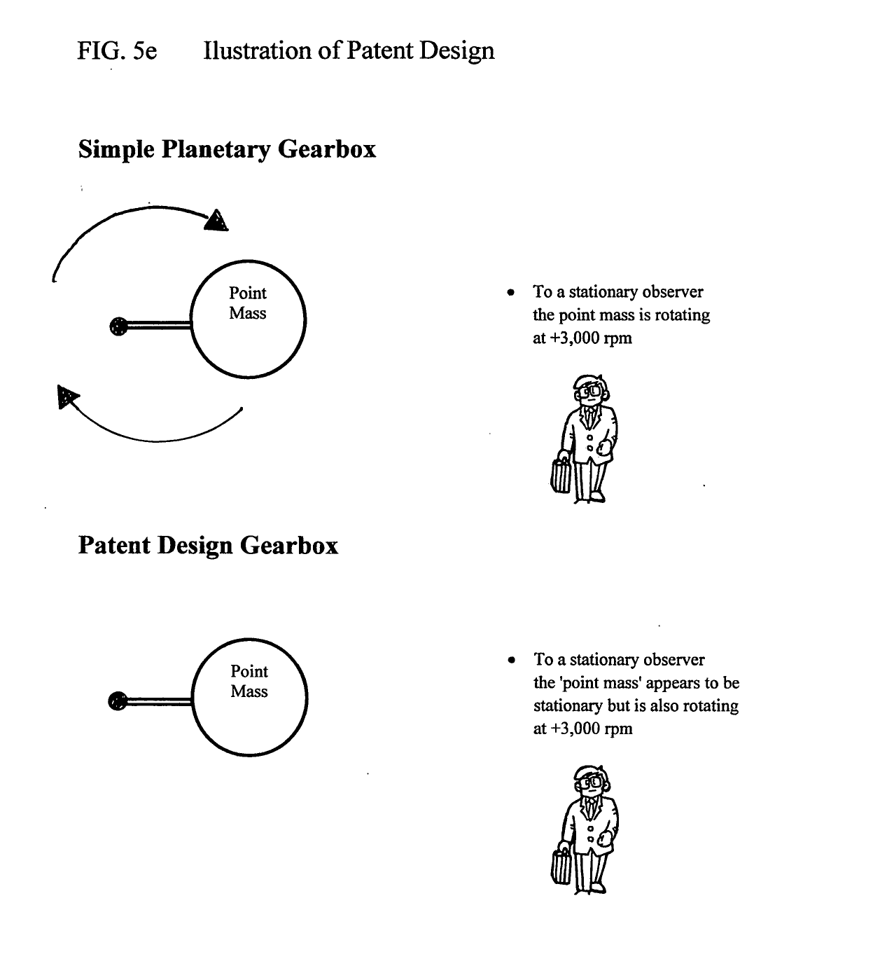

The centripetal force generated is the result of its mass×velocity2/radius. The centripetal force calculation is illustrated in FIG. 7

On a ‘simple planetary gearbox’ when the planet is held and the power input is to the ring gear, power output is to the sun gear, rotational speed is increased and rotational torque is reduced. The rotational direction power output is in the opposite direction of the drive member. FIG. 4

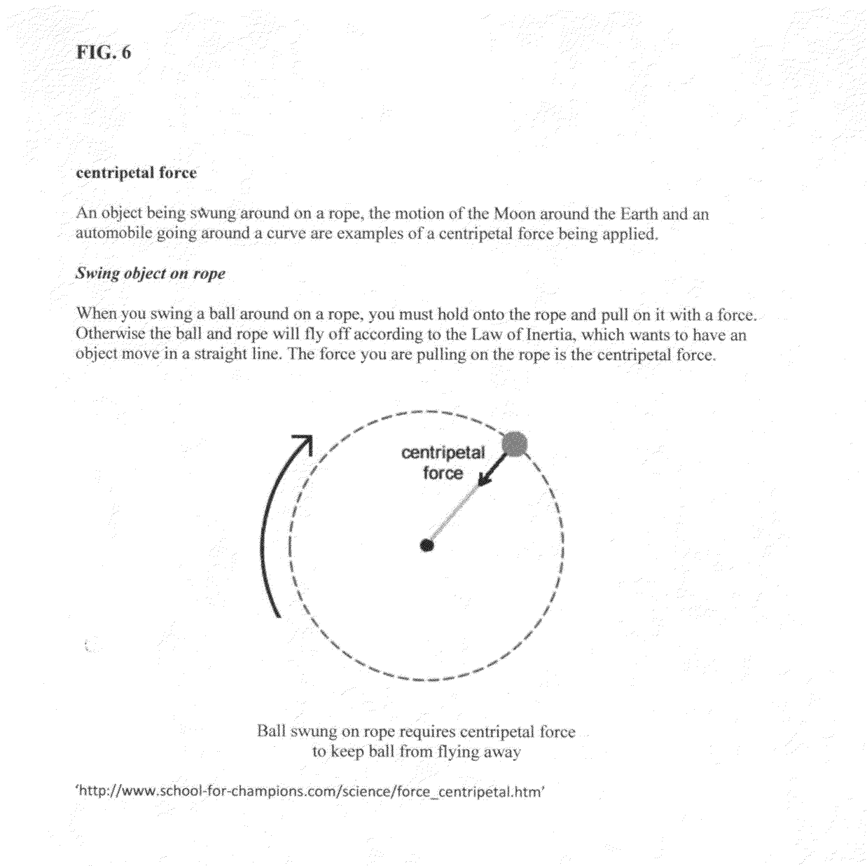

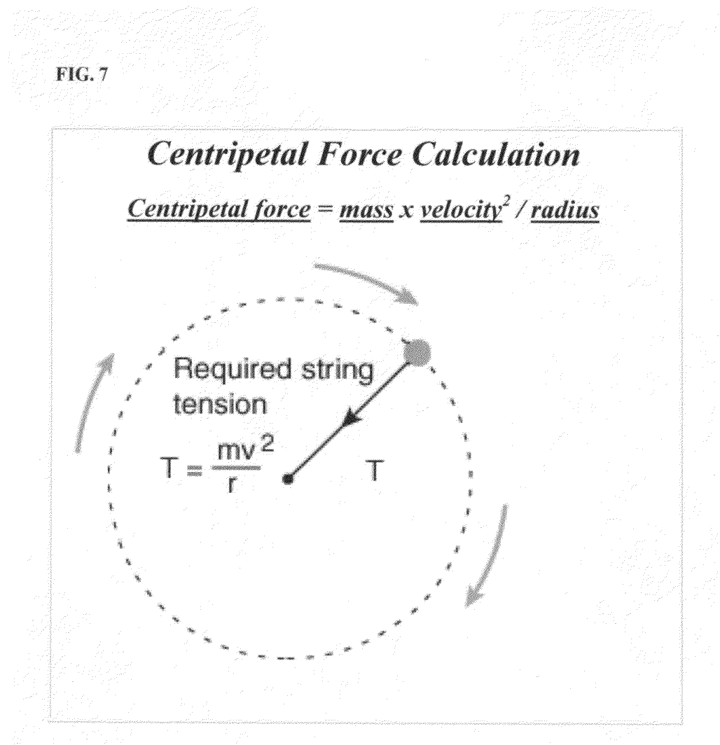

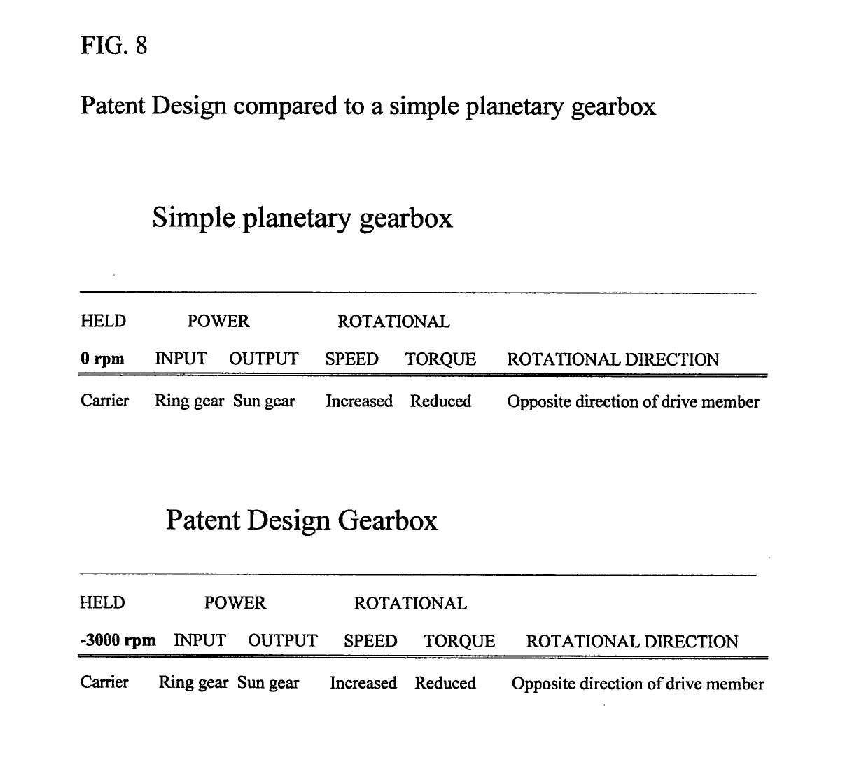

This patent design has only one change to this simple planetary gearbox outlined in FIG. 4. In a simple planetary gearbox the carrier is held stationary at 0 rpm while in this Patent Design the carrier is held stationary at −3000 rpm in this example. FIG. 5d Increasing the rpm to the ring gear above −3000 rpm to −4000 rpm, with a 1:3 ratio speed increase gearbox, results in rotational speed being increased, rotational torque being reduced, and the rotational direction power output in the opposite direction of the drive member identical to a simple planetary gearbox as shown in. FIG. 4 FIG. 8

To a stationary observer looking at a ‘simple planetary gearbox’ the ‘point mass’ is rotating at +3000 rpm but to a stationary observer looking at this ‘patent design gearbox’ the ‘point mass’ appears to be stationary but is also rotating at +3000 rpm. FIG. 5e

FIG. 5d illustrates some examples of ‘Timing Documentation—RPM’ that can be utilized in this Angular Momentum engine.

This design allows the variables, the point mass, point mass velocity, radius of the point mass arm, pulley ratio, and the gearbox ratio to be increased or decreased to fit the desired centripetal force needed for a specific application.

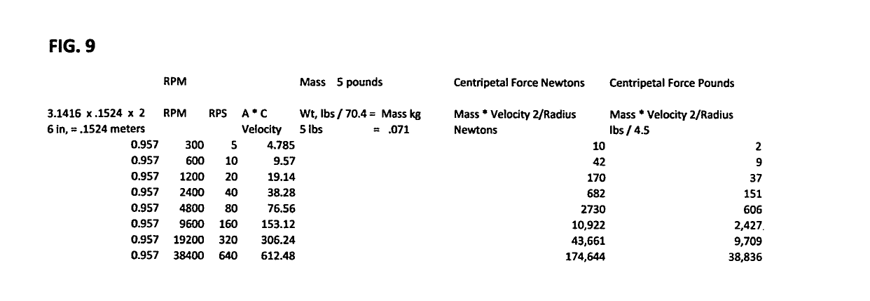

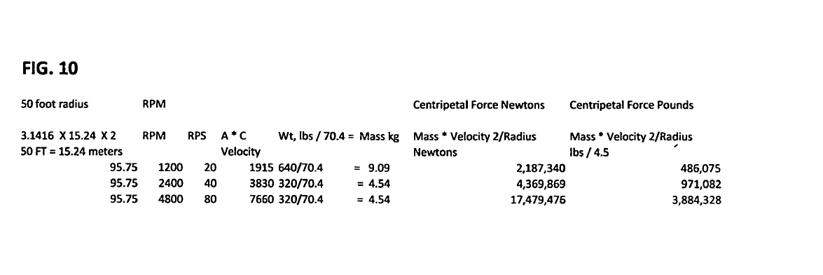

If you double the point mass or radius the Centripetal force doubles. If you double the speed the Centripetal force quadruples, Forces from a few to millions of pounds of centripetal force can be generated. FIG. 9 illustrates examples of high centripetal forces generated from the product of a small mass at high revolutions per minute with a 6 inch radius, FIG. 10 illustrates examples of high centripetal forces generated from the product of a large mass at low revolutions per minute with a 50 foot radius. As indicated above the centripetal force needed for a specific application are dependent on the Centripetal Force Calculator FIG. 7.

The Timing documentation FIG. 5a, illustrates the starting and ending timing marks for ‘Point Mass 1’ and ‘Point Mass 2’ before and after spin-up. FIG. 5b illustrates the timing marks for neutral thru full power for ‘Point Mass 1’ and ‘Point Mass 2’. during forward acceleration, FIG. 5c illustrates the timing marks for neutral thru full power for ‘Point Mass 1’ and ‘Point Mass 2’ during reverse acceleration.

An ‘electronic accelerator pedal’ or ‘joy stick’ is used to control the point masses movement from neutral for minimum to maximum power. A movement of 1 degree for minimum power to a maximum of 90 degrees for full power.

1. This invention ‘Angular Momentum Engine’ changes rotating ‘center seeking’ centripetal force to linear ‘center seeking’ centripetal force.
This change in force as indicated in [0035] is accomplished by changing the relative velocity and relative motion of a ‘point mass’ to a stationary reference point.
The linear centripetal force generated in this ‘Angular Momentum Engine’ can vary as the centripetal force [0035] is a product of the mass times the velocity squared divided by the radius.
When these forces are used in pairs [0036] the ‘point masses’ can be used to provide a neutral position where the centripetal forces are balanced and also provide minimum to full power, forward or reverse, by moving each ‘point mass’ plus or minus 1 to 90 degrees from the neutral position.
The linear centripetal force [0035] can be used to power land, sea, as well as space vehicles.
This design allows the variables, the point mass, point mass velocity, radius of the point mass arm, pulley ratio, and gearbox ratio to be increased or decreased to fit the desired centripetal force needed for a specific application from a few pounds to millions of pounds of Centripetal Force.
Doubling the mass or radius doubles the Centripetal force, doubling the speed quadruples the Centripetal force.
This patent can optionally power a generator to create current.
